(19) United States
(12) Patent Application Publication
(10) Pub. No.: US 2020/0044256 A1
(43) Pub. Date: Feb. 6, 2020

(54) Lead Alloy, Electrode And Accumulator

(71) Applicant: Hoppecke Batterien GmbH & Co. KG, Brilon (DE)

(72) Inventors: Eduardo CATTANEO, Brilon (DE); Bernhard RIEGEL, Brilon (DE)

(21) Appl. No.: 16/524,853

(22) Filed: Jul. 29, 2019

(30) Foreign Application Priority Data
Jul. 31, 2018 (EP) 18186627.8

(51) Int. Cl. H01M 4/66; H01M 10/06; H01M 4/73; H01M 4/22; C22C 11/06

(52) U.S. Cl. CPC H01M 4/662; H01M 10/06; C22C 11/06; H01M 4/22; H01M 4/73

(57) ABSTRACT

A lead alloy for an electrode grid comprises lead, 0.04 wt. %-0.08 wt. % calcium and 0.003 wt. %-0.025 wt. % of at least one rare earth metal. The at least one rare earth metal being yttrium. An electrode having an electrode framework formed at least partially of at least one of the lead alloys, a lead-acid accumulator having the electrode are also described.

### CROSS-REFERENCE TO RELATED APPLICATIONS

This application claims the benefit and priority of European Patent Application No. 18186627.8, filed on Jul. 31, 2018. The entire disclosure of the above application is incorporated herein by reference.

### FIELD

The disclosure relates to lead alloys comprising at least one rare earth metal, uses of the lead alloys according to the disclosure, an electrode comprising an electrode framework at least partially consisting of one of the lead alloys according to the disclosure, and a lead-acid accumulator comprising an electrode according to the disclosure.

### BACKGROUND

Lead alloys as a material for electrode frameworks for use in lead-acid accumulators are basically known from prior art. Electrodes mostly have a fixed electrode framework that serves to receive a pasty active electrode mass. The electrode framework is usually designed as an electrode grid. However, other forms are also known from prior art. Regardless of the final form of the electrode framework, lead alloys are usually referred to as electrode grid alloys.

Various factors play a role in the selection of the lead alloy. On the one hand, it is necessary that the lead alloy can be processed into electrode frameworks in an economically reasonable manner. Furthermore, the lead alloy must have a comparatively good mechanical stability in order to be able to support both its own comparatively high weight and the weight of the electrode mass over the entire service life of the accumulator. In addition, when used as intended in a lead-acid accumulator, the electrode framework is always in contact with a highly corrosive electrolyte on the one hand and with the corrosive components of the active electrode mass on the other. In addition to the aforementioned properties, the lead alloy must therefore also be corrosion-resistant.

In this context, lead-calcium-cerium-containing alloys are known from document U.S. Pat. No. 2,860,969 A, for example. This document is concerned with removing the disadvantages of lead-antimony alloys as electrode grid material. Antimony was initially used in lead alloys to give the alloy mechanical stability. The specifically proposed PbCaSnCe-containing alloy provides calcium as a substitute for antimony to provide the necessary mechanical stability and prevent the deposition of antimony on the negative plate due to positive grid corrosion. It is known that the contamination of the negative active mass by antimony leads to an increased water loss through electrolysis and sulfation of the negative plates.

In contrast, the alloy component cerium serves to improve the corrosion properties by refinement of the grain sizes. Grids with coarse-grained structures have webs and frames consisting of a few grains. In this case, the corrosion attack at grain boundaries quickly penetrates deeply into the webs or frames. This kind of intergranular corrosion usually leads to premature grid disintegration.

However, electrode frameworks from the above-mentioned alloys have the disadvantage that they tend to grid growth during normal operation, which can lead to an impairment of the positive grid mass bonding and culminate in considerable capacity losses of the accumulator. The phenomenon of grid growth is the result of an increasing lack of creep resistance of the grid alloys over time. This irreversible loss of mechanical strength is also called “ageing”. Under these conditions, the increasing thickness of the corrosion layer creates an axial force that results in significant elongation of the grid webs and frames.

### SUMMARY

Accordingly, the disclosure is based on the complex technical object of providing an alloy which is suitable as a material for electrode frameworks, i.e. can be processed economically in industrial production, is sufficiently mechanically stable and corrosion-resistant and also has at least a reduced tendency to grid growth during operation in a lead-acid accumulator.

To achieve this object, the disclosure proposes a lead alloy comprising lead, 0.03 wt. %-0.09 wt. % calcium and 0.003 wt. %-0.025 wt. % of at least one rare earth metal, said at least one rare earth metal being yttrium.

The “rare earth metals” in terms of the disclosure include the metals of the lanthanide group and the metals of the 3rd subgroup of the periodic table scandium and yttrium. A “lead alloy” means an alloy composition of the type that contains a predominant proportion by weight of lead. The potential other alloy components specified add up to 100 wt. % with the predominant remainder lead.

### DETAILED DESCRIPTION

The lead alloy according to the disclosure is characterized by the inventive idea of exploiting the synergetic effect of a combination of lead and rare earth metal in the specified composition in order to obtain an alloy that exhibits reduced grid growth compared to lead alloys known from prior art.

In this context, it has been shown surprisingly that the grid growth of a calcium-containing lead alloy can be reduced during its intended use by selecting a suitable rare earth metal as the alloy component. It has been found that with calcium-containing lead alloys this effect can be largely achieved by the rare earth metal yttrium. In this special alloy composition, yttrium unfolds a previously unrecognized double effect by increasing corrosion resistance through grain size refinement on the one hand and inhibiting the tendency to grid growth caused by the calcium component on the other.

According to the disclosure, the proportion by weight of yttrium in the calcium-containing lead alloy is 0.003 wt. % to 0.025 wt. %. Preferably, the lead alloy contains 0.005 wt. % to 0.020 wt. % yttrium. Particularly preferably, the lead alloy has a proportion by weight of 0.010 wt. % to 0.020 wt. % yttrium. It has been shown that yttrium in this quantitative composition has particularly advantageous properties with regard to grid growth and corrosion resistance.

According to a preferred configuration of the disclosure, the calcium-containing lead alloy may contain further rare earth metals, in particular lanthanides or misch metals of lanthanides. On the one hand, these serve to improve the corrosion properties of the alloy. It has also been shown that in combination with yttrium they further inhibit the growth of the electrode framework when used as intended. In this respect, a combination of yttrium and a La—Ce misch metal has proven to be particularly effective.

According to the disclosure, the proportion by weight of the other rare earth metal is at most of 0.025 wt. %. It is preferably 0.003 wt. % to 0.025 wt. %. Preferably, the proportion by weight of the at least one rare earth metal is 0.005 wt. % to 0.020 wt. %. Especially preferred calcium-containing lead alloys in this context are Pb—Ca—La—Y, Pb—Ca—Ce—Y or Pb—Ca—La—Ce—Y. With regard to the quantitative composition, the alloys Pb—Ca0.07-La0.01-Y0.01, Pb—Ca0.07-Ce0.01-Y0.01 or Pb—Ca0.07-La0.01-Ce0.005-Y0.005 in particular are preferred.

According to a preferred feature of the disclosure, the calcium-containing lead alloy of the disclosure may contain additional alloy. These alloy components are selected from the group Sn, Ag, Ba, Bi and Al. The alloy components serve to improve various properties of the lead alloy. In particular, they serve to optimize the lead alloy for different processing methods. In the field of casting techniques, such processing methods include in particular drop-casting, die-casting, continuous casting (ConCast) and rolling/punching techniques.

In combination with the calcium-containing lead alloy according to the disclosure, the above-mentioned optional alloy components have the following technical effects:

Tin (Sn) slows down the ageing of the microstructure, increases the conductivity of the corrosion layers and thus contributes to increasing the input current capability, cycle stability and the recovery capability of the batteries after deep discharges. The proportion by weight of Sn in the alloy is preferably a maximum of 2.0 wt. % and particularly preferably from 0.2 wt. % to 2.0 wt. %.

Silver (Ag) improves the corrosion resistance and increases the creep resistance of lead alloys at high temperatures. The proportion by weight of Ag in the alloy is preferably a maximum of 0.035 wt. % and particularly preferably from 0.008 wt. % to 0.035 wt. %.

Barium (Ba) increases the mechanical strength of lead alloys (even in comparatively small quantities). The proportion by weight of Ba in the alloy is preferably a maximum of 0.07 wt. % and particularly preferred from 0.03 wt. % to 0.07 wt. %.

Bismuth (Bi) contributes to the grid hardness. The proportion by weight of Bi in the alloy is preferably a maximum of 0.03 wt. % and particularly preferably from 0.005 wt. % to 0.03 wt. %.

Aluminum (Al) protects the melts in the lead alloy production process against air oxidation. Al is preferably only used together with Ca or Ba, as melts containing calcium and/or barium tend to oxidize in the air. The proportion by weight of Al in the alloy is preferably a maximum of 0.012 wt. % and particularly preferably from 0.005 wt. % to 0.012 wt. %.

The disclosure also relates to the use of the lead alloys of the disclosure as material for an electrode structure for lead-acid accumulators. The use as material for an electrode grid is preferred. By using lead alloys in accordance with the disclosure, an electrode framework suitable for use in a lead-acid accumulator can be provided, the service life of which is extended at least by reducing the growth effect of the electrode framework during normal operation.

In addition, the lead alloys according to the disclosure can be used in various processing procedures, in particular in the field of casting technology. Preferably, the lead alloys according to the disclosure are intended for use as a starting material in a manufacturing process for electrode frameworks, in particular electrode grids. The calcium-containing alloys can be processed with conventional casting machines, i.e. using drop-casting and die-casting grid manufacturing processes.

The lead alloy is comparatively easy to process by selecting its components, so that it can be used in a wide variety of processes in contrast to alloys known from prior art.

The disclosure further relates to an electrode for a lead-acid accumulator with an electrode framework that is at least partially formed from at least one of the lead alloys in accordance with the disclosure. According to a preferred form of the disclosure, the electrode framework is made entirely of only one of the lead alloys according to the disclosure. The use of the lead alloys according to the disclosure improves the service life of the electrode and the accumulator as a whole.

According to a preferred further development of the disclosure, the electrode has a paste-like active mass that is absorbed by the electrode framework. It has been shown that the lead alloys according to the disclosure interact particularly well with the active electrode mass. The adhesion of the active electrode mass to the electrode framework is thus increased, resulting in improved mechanical stability and improved charge-discharge behavior of the electrode as a whole.

The disclosure also relates to a lead-acid accumulator with an electrode according to the disclosure. By using an electrode with an electrode framework made of a lead alloy according to the disclosure, the service life of the accumulator is improved by reducing electrode growth. Consequently, a lead-acid accumulator with a comparatively long service life is provided. The lead-acid accumulator is preferably a VRLA accumulator (valve-regulated lead-acid accumulator). This makes the accumulator particularly suitable for use in traction batteries and stationary systems.

Examples of preferred alloy compositions are given below:

### Exemplary Embodiment 1

| | |
|---|---|
| 0.04 wt. %-0.08 wt. % | Ca |
| 0.8 wt. %-1.8 wt. % | Sn |
| 0.01 wt. %-0.025 wt. % | Ag |
| 0.008 wt. %-0.020 wt. % | Y |
| 0.005 wt. %-0.014 wt. % | Al |
| rest | Pb. |

### Exemplary Embodiment 2

| | |
|---|---|
| 0.04 wt. %-0.08 wt. % | Ca |
| 0.8 wt. %-1.8 wt. % | Sn |
| 0.01 wt. %-0.025 wt. % | Ag |
| 0.008 wt. %-0.020 wt. % | Y |
| 0.005 wt. %-0.014 wt. % | Al |
| 0.008 wt. %-0.020 wt. % | La |
| rest | Pb. |

### Exemplary Embodiment 3

| | |
|---|---|
| 0.04 wt. %-0.06 wt. % | Ca |
| 0.8 wt. %-1.8 wt. % | Sn |
| 0.01 wt. %-0.025 wt. % | Ag |
| 0.01 wt. %-0.02 wt. % | Y |
| 0.005 wt. %-0.014 wt. % | Al |
| 0.008 wt. %-0.020 wt. % | La |
| 0.02 wt. %-0.04 wt. % | Ba |
| rest | Pb. |

### Exemplary Embodiment 4

| | |
|---|---|
| 0.04 wt. %-0.08 wt. % | Ca |
| 0.8 wt. %-1.8 wt. % | Sn |
| 0.01 wt. %-0.025 wt. % | Ag |
| 0.005 wt. %-0.015 wt. % | Y |
| 0.005 wt. %-0.014 wt. % | Al |
| 0.008 wt. %-0.016 wt. % | La |
| 0.01 wt. %-0.02 wt. % | Ce |
| rest | Pb. |

What is claimed:

1. A lead alloy for an electrode grid, comprising lead, 0.04 wt. %-0.08 wt. % calcium and 0.003 wt. %-0.025 wt. % of at least one rare earth metal, wherein yttrium is the rare earth metal.

2. The lead alloy according to claim 1 consisting of:

| | |
|---|---|
| 0.003 wt. %-0.025 wt. % | Y |
| 0.04 wt. %-0.08 wt. % | Ca |
| 0.0 wt. %-2.0 wt. % | Sn |
| 0.0 wt. %-0.035 wt. % | Ag |
| 0.0 wt. %-0.07 wt. % | Ba |
| 0.0 wt. %-0.03 wt. % | Bi |
| 0.0 wt. %-0.012 wt. % | Al |
| rest | Pb; |

wherein the sum of all parts by weight of the alloy components in the lead alloy is 100 wt. %.

3. The lead alloy according to one of claim 1 further including at least one additional rare earth metal, said additional rare earth metal being a lanthanide, in particular La, Ce or a LaCe misch metal.

4. The lead alloy according to one of claim 1 consisting of:

| | |
|---|---|
| 0.003 wt. %-0.025 wt. % | Y |
| 0.003 wt. %-0.025 wt. % | of at least one lanthanide |
| 0.04 wt. %-0.08 wt. % | Ca |
| 0.8 wt. %-1.8 wt. % | Sn |
| 0.0 wt. %-0.035 wt. % | Ag |
| 0.0 wt. %-0.07 wt. % | Ba |
| 0.0 wt. %-0.03 wt. % | Bi |
| 0.0 wt. %-0.012 wt. % | Al |
| rest | Pb; |

wherein the sum of all parts by weight of the alloy components in the lead alloy is 100 wt. %.

5. The lead alloy according to claim 1 consisting of:

| | |
|---|---|
| 0.003 wt. %-0.025 wt. % | Y |
| 0.003 wt. %-0.025 wt. % | of at least one lanthanide |
| 0.04 wt. %-0.08 wt. % | Ca |
| 0.8 wt. %-1.8 wt. % | Sn |
| 0.01 wt. %-0.02 wt. % | Ag |
| 0.0 wt. %-0.07 wt. % | Ba |
| 0.0 wt. %-0.03 wt. % | Bi |
| 0.05 wt. %-0.012 wt. % | Al |
| rest | Pb; |

wherein the sum of all parts by weight of the alloy components in the lead alloy is 100 wt. %.

6. A method of forming an electrode framework for a lead-acid accumulator comprising constructing an electrode grid from the lead alloy according to claim 1.

7. A method of producing an electrode framework for lead-acid accumulators comprising drop-casting or die-casting the lead alloy according to claim 1.

8. An electrode for a lead-acid accumulator comprising: an electrode framework which is formed at least partially from at least one lead alloy according to claim 1.

9. The electrode according to claim 8, further comprising a pasty active electrode composition which is absorbed by the electrode framework.

10. A lead-acid accumulator comprising an electrode according to claim 8.
